(19) United States
(12) Patent Application Publication
(10) Pub. No.: US 2022/0051049 A1
(43) Pub. Date: Feb. 17, 2022

(54) USING META-LEARNING TO OPTIMIZE AUTOMATIC SELECTION OF MACHINE LEARNING PIPELINES

(71) Applicant: International Business Machines Corporation, Armonk, NY (US)

(72) Inventors: Dakuo Wang, Cambridge, MA (US); Chuang Gan, Cambridge, MA (US); Gregory Bramble, Larchmont, NY (US); Lisa Amini, Weston, MA (US); Horst Cornelius Samulowitz, White Plains, NY (US); Kiran A. Kate, Chappaqua, NY (US); Bei Chen, Blanchardstown (IE); Martin Wistuba, Dublin (IE); Alexandre Evfimievski, San Jose, CA (US); Ioannis Katsis, San Jose, CA (US); Yunyao Li, San Jose, CA (US); Adelmo Cristiano Innocenza Malossi, Adliswil (CH); Andrea Bartezzaghi, Rueschlikon (CH); Ban Kawas, Palo Alto, CA (US); Sairam Gurajada, San Jose, CA (US); Lucian Popa, San Jose, CA (US); Tejaswini Pedapati, White Plains, NY (US); Alexander Gray, Yonkers, NY (US)

(21) Appl. No.: 16/990,965

(22) Filed: Aug. 11, 2020

(51) Int. Cl. G06K 9/62; G06N 20/00

(52) U.S. Cl. CPC G06K 9/623; G06N 20/00; G06K 9/6263

(57) ABSTRACT

A computer automatically selects a machine learning model pipeline using a meta-learning machine learning model. The computer receives ground truth data and pipeline preference metadata. The computer determines a group of pipelines appropriate for the ground truth data, and each of the pipelines includes an algorithm. The pipelines may include data preprocessing routines. The computer generates hyperparameter sets for the pipelines. The computer applies preprocessing routines to ground truth data to generate a group of preprocessed sets of said ground truth data and ranks hyperparameter set performance for each pipeline to establish a preferred set of hyperparameters for each of pipeline. The computer selects favored data features and applies each of the pipelines, with associated sets of preferred hyperparameters, to score the favored data features of the preprocessed ground truth data. The computer ranks pipeline performance and selects a candidate pipeline according to the ranking.

### BACKGROUND

The present invention relates generally to the fields of information visualization, artificial intelligence, automatic machine learning, data science and more specifically, to predictive systems that optimize the selection of machine learning pipelines.

Machine learning systems identify patterns in stored data to form computerized models that are able to predict scoring outcomes for similar data. Automatic Machine Learning (“Auto ML”) deals with streamlining various aspect of the machine learning process.

Auto ML routines automate the typically human intensive and otherwise highly skilled end-to-end tasks involved in building and operationalizing AI models. Unlike typical machine learning applications which are readily applied to homogenous training data, Auto ML applications are used in situations where data format and content vary from widely. To accommodate this variety of input data, Auto ML systems address various aspects of the machine learning process, including data preparation, data feature engineering, selection of algorithms, hyperparameter selection.

### SUMMARY

According to one embodiment, a computer-implemented method of automatically selecting a machine learning model pipeline using a meta-learning machine learning model includes receiving, by the computer, ground truth data, pipeline preference metadata. The computer determines a group of pipelines appropriate for the ground truth data. Each pipeline includes an algorithm and at least one pipeline includes an associated data preprocessing routine. The computer generates a target quantity of hyperparameter sets for each of the pipelines. The computer applies the preprocessing routines to the ground truth data to generate sets of preprocessed ground truth data for each pipeline. The computer ranks the performance of each hyperparameter set for the group of pipelines to establish a preferred set of hyperparameters for each of the pipelines. The computer applies a sentence embedding algorithm to select favored data features for scoring. The computer applies each of the pipelines with the associated preferred set of hyperparameters to score the favored data features of an appropriately preprocessed set of ground truth data and ranks the pipeline performance accordingly. The computer selects a candidate pipeline in accordance, at least in part, with the pipeline performance ranking. According to other aspects of the invention, the method also includes ranking pipeline performance based, as least in part, on a pipeline attribute provided by a user. According to other aspects of the invention, the method also includes assembling a group of pipelines into a cooperative ensemble. According to other aspects of the invention, the method also includes highlighting occurrences of pipeline scoring agreement. According to other aspects of the invention, the method also includes presenting the ensemble to a user for feedback, and pipelines in the ensemble are selectively removed from the ensemble in accordance with the feedback. According to other aspects of the invention, the method also includes selecting the favored data features, at least in part, in consideration of data processing time. According to other aspects of the invention, the computer also includes receives domain knowledge regarding the data features from a user and applying the domain knowledge as a form of feature engineering. According to other aspects of the invention, the method also includes ranking pipeline performance based, at least in part, in consideration of data scoring accuracy. According to other aspects of the invention, the method also includes selecting the sets of hyperparameters, at least in part, in accordance with a statistical likelihood of providing best performance for the algorithms associated with said hyperparameters.

According to another embodiment a system of automatically selecting a machine learning model pipeline using a meta-learning machine learning model, which comprises: a computer system comprising a computer readable storage medium having program instructions embodied therewith, the program instructions executable by a computer to cause the computer to: receive ground truth data and pipeline preference metadata; determine a plurality of pipelines appropriate for said ground truth data, wherein each of said plurality of pipelines includes an algorithm and at least one said pipelines includes an associated data preprocessing routine; generate a target quantity of hyperparameter sets for each of said plurality of pipelines; apply said preprocessing routines to said ground truth data to generate a plurality of preprocessed sets of said ground truth data; rank hyperparameter performance of each of said hyperparameter sets for each of said pipelines to establish a preferred set of hyperparameters for each of said plurality of pipelines; apply a sentence embedding algorithm to select favored data features; apply each said pipelines with said preferred set of hyperparameters to score said favored data features of an appropriately preprocessed one of said plurality of preprocessed sets of ground truth data and ranking pipeline performance in accordance therewith; select a candidate pipeline in accordance, at least in part, with said pipeline performance ranking.

According to another embodiment, a computer program product to automatically select a machine learning model pipeline using a meta-learning machine learning model optimize input component enablement for a plurality of participants in an electronic group meeting, the computer program product comprising a computer readable storage medium having program instructions embodied therewith, the program instructions executable by a computer to cause the computer to: receive, using said computer, ground truth data and pipeline preference metadata; determine, using said computer, a plurality of pipelines appropriate for said ground truth data, wherein each of said plurality of pipelines includes an algorithm and at least one said pipelines includes an associated data preprocessing routine; generate, using said computer, a target quantity of hyperparameter sets for each of said plurality of pipelines; apply, using said computer, said preprocessing routines to said ground truth data to generate a plurality of preprocessed sets of said ground truth data; rank, using said computer, hyperparameter performance of each of said hyperparameter sets for each of said pipelines to establish a preferred set of hyperparameters for each of said plurality of pipelines; apply, using said computer, a sentence embedding algorithm to select favored data features; apply, using said computer, each said pipelines with said preferred set of hyperparameters to score said favored data features of an appropriately preprocessed one of said plurality of preprocessed sets of ground truth data and ranking pipeline performance in accordance therewith; select, using said computer, a candidate pipeline in accordance, at least in part, with said pipeline performance ranking.

The present disclosure recognizes the shortcomings and problems associated with relying on processing power to replicate data processing scientist expertise and insight.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a computer-implemented predictive system that uses meta-learning to optimize automatic selection of machine learning pipelines.

FIG. 2 is a flowchart illustrating a method implemented using the system shown in FIG. 1.

FIG. 3 is a table showing a format for associating algorithms with exemplary data types in accordance with aspects of the system shown in FIG. 1.

FIG. 4 is a table showing a format for identifying aspects of machine learning pipelines in accordance with aspects of the system shown in FIG. 1.

FIG. 5 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 6 depicts a cloud computing environment according to an embodiment of the present invention.

FIG. 7 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

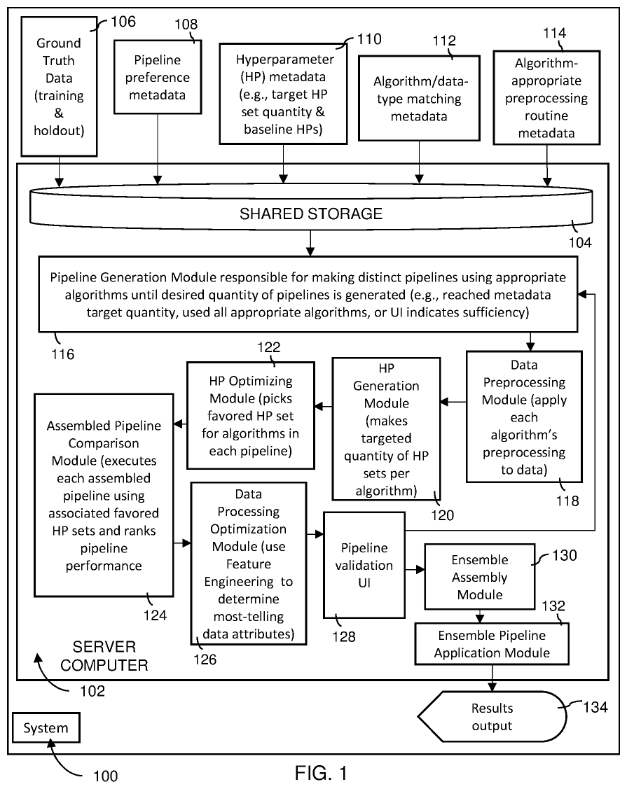

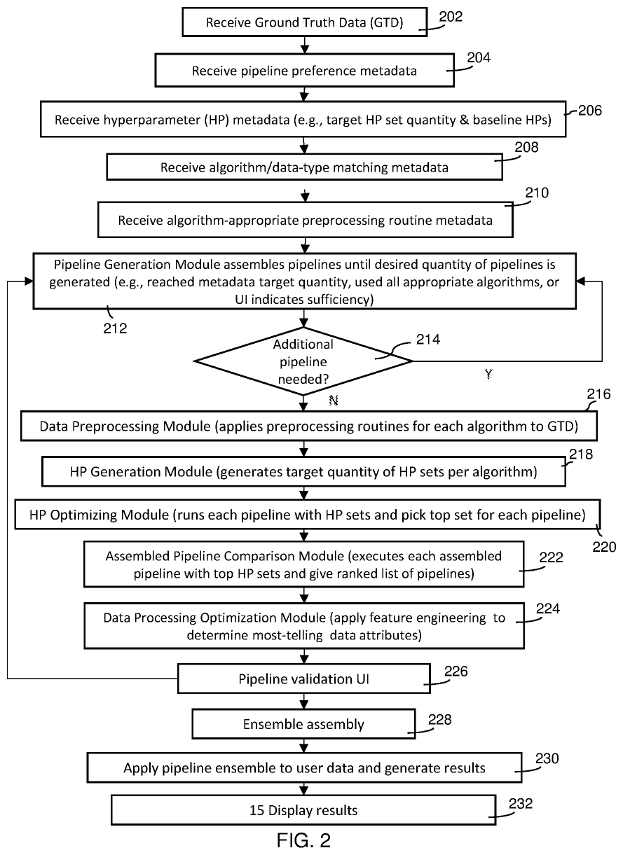

Now with combined reference to the Figures generally and with particular reference to FIG. 1 and FIG. 2 an overview of a method 200 for using meta-learning to optimize automatic selection of machine learning pipelines usable within a system 100 as carried out by a server computer 102 having optional shared storage 104 and aspects that automatically select machine learning pipelines. The server computer 102 is in communication with a source of Ground Truth Data (GTD) 106 useful for training and validating the models to be selected by the system 100. According to aspects of the present invention, the GTD 106 is text-based and can reflect many different kind of a of information. Some representative data types include supermarket sales performance, online vendor sales performance, customer reviews, and product ratings. Other kinds of information and data types may also be accommodated in accordance with the judgment of one skilled in this art. The server computer 102 is also in communication with a source of pipeline preference metadata PPM 108, which provides desired attributes for the pipelines to be selected by the server computer. The Pipeline Preference Metadata (PPM) 108 may be provided by a user and can include a variety of pipeline selection criteria including constraints on number of pipelines to be selected; maximum or minimum selection run time; pipeline stability; maximum and minimum model training time, desired model accuracy threshold; forced pipelines and features that must be selected. The pipeline preference metadata 108 may contain other selection criteria as specified by one skilled in this art. The server computer is also in communication with a source of hyperparameter metadata 110 that provides information about hyperparameter values (not shown) to be assigned to the algorithms selected by the server computer 102. The hyperparameter metadata 110 can indicate which hyperparameters are known by those skilled in the art to be acceptable for each of the algorithms available for selection by the server computer 102. The hyperparameter metadata 110 may also include a target quantity of hyperparameter sets to be generated and ranked for each pipeline selected. The sever computer 102 also receives algorithm/data type matching metadata 112 that indicates which of several available algorithms are appropriate for modeling various types of data. The server computer 102 also receives algorithm-appropriate preprocessing routines metadata 114 which indicates which of several available data preprocessing routines are suitable for treating raw data for use with algorithms selected in accordance with aspects of the method of the present invention.

As will be described more fully below, the server computer 102 includes a Pipeline Generation Module (PGM) 116 that uses the algorithm/data-type matching metadata 112, and algorithm-appropriate preprocessing routines metadata to generate multiple pipelines in accordance with the using the pipeline preference metadata 108. The PGM 116 may also accept input from a user to guide pipeline generation. The server computer also includes a Data Preprocessing Module (DPM) 118 that applies each of the preprocessing routines identified as appropriate for the algorithms in the pipelines generated by the PGM. The server computer includes a Hyperparameter Generation Module (HGM) 120 that generates a targeted quantity of hyperparameter sets for the algorithms associated with each of the pipelines generated by the PGM 116. The server computer 102 includes a Hyperparameter Optimizing Module (HOM) 122 that identifies a preferred hyperparameter set for the algorithms in each pipeline. The server computer 102 includes an Assembled Pipeline Comparison Module (APCM) 124 that executes each of the pipelines generated by the PGM, using the favored hyperparameter sets identified for each algorithm by the HOM 122. The server computer 102 also includes a Data Processing Optimization Module (DPOM) 126 that uses feature engineering to determine the most revealing data attributes. The server computer 102 includes a Pipeline Validation User Interface (PVUI) 128 that allows a user to examine pipeline execution results to correct, remove selected pipelines, and otherwise give input regarding pipeline performance to increase result interpretability and user confidence. The server computer 102 includes an Ensemble Assembly Module (EAM) 130 that combines multiple pipelines into a cooperative bundle. The server computer 102 also includes an Ensemble Pipeline Application Module 132 applies the pipelines in the ensemble to provided data 106 which can indicate whether multiple pipelines provide results that agree. The server computer 102 may send data analysis results to a user display, recording device, or other output device 134 for acceptance and application by a user.

Now, with particular reference to FIG. 2, aspects of the computer-implemented method for using meta-learning to optimize automatic selection of machine learning pipelines according to the present invention will be described further. The server computer 102 receives Ground Truth Data 106 which is deemed to be accurate, and this data is used to train the pipeline models selected by the server computer in accordance with aspects of this invention. A portion (e.g., 80%) of the GTD 106 is used as pipeline training data, and the remainder (e.g., 20%) of the data is reserved as holdout data for validation of the pipelines selected in accordance with the present method.

The server computer 102 at block 204 receives PPM 108 which includes preference information (e.g., from a user or other guiding source selected by one of ordinary skill in this field) that gives parameters for the PGM 116. The PPM 108 may include information that instructs the server computer 102 regarding how many pipelines to target for assembly, desired testing, modeling, and training run time ranges, desired performance (e.g., accuracy, stability, or other value selected by one of ordinary skill in this field) thresholds, certain required pipeline arrangements, features to include or an order to stop or pause pipeline generation to allow for pipeline inspection.

The server computer 102 at block 206 receives hyperparameter metadata which, in addition to target hp set quantities, may include values appropriate (e.g., for each of the algorithms included in pipelines generated by the PGM 116 of the server computer 102. The hyperparameter metadata 110 may also include information about which hyperparameters are most likely to produce desired results (e.g., accuracy, computation time, consistency, and other desirable attributes known to those of skill in this art) when used with the associated pipeline algorithms. While hyperparameters vary widely from one algorithm to another, one example set for the CNN algorithm includes a layer number, a number of neurons, and a learning rate. Exemplary values for layer number could include values 2, 3, 4, or 8; exemplary neuron values could be 418, 1024; and exemplary learning rate values could be 0.5 or 0.05. Other values could be provided in accordance with the judgment of one skilled in this field, chosen to match known properties of the algorithms selected for pipeline use.

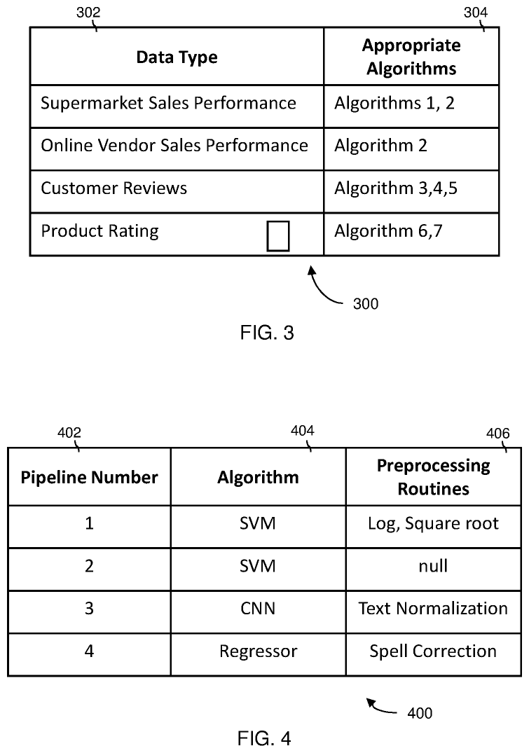

The server computer 102 receives, at block 208, algorithm/data-type matching metadata 112, an example 300 of which is shown in FIG. 3, wherein certain data types 302 are shown to match appropriate algorithms 304. For example, the data type, “Supermarket Sales Performance” is shown schematically to be relevant to two appropriate algorithms, as indicated with generic algorithm placeholders. It is noted that some algorithms might be appropriate for use with more than one data type, while other algorithms might only be suitable for one type of data.

The server computer 102 receives, at block 210, algorithm-appropriate preprocessing routine metadata 114, which indicates which pre-processing routines are for best-suited for the various algorithms which may be selected in accordance with aspects of this invention. This preprocessing routine metadata 114 is applied, along with algorithm/data-type matching metadata 112, by the PGM 116 in block 212 to assemble a set of pipelines that meets the characteristics set forth in the PPM 108 (e.g., a targeted number of pipelines, data-type matching algorithms, and appropriate preprocessing routines). Several examples of pipeline elements are shown schematically in FIG. 4, wherein numbered pipelines 402 are shown to include a selected algorithm 404 and associated preprocessing routines 406. It is noted that some algorithms 404 might function best, for a variety of reasons (e.g., inherent format characteristics of certain data types), with no preprocessing routines 406 needed, and this is indicated by a “null” value entry. Although FIG. 4 indicates Convolutional Neural Network (CNN), Support Vector Machine (SVM), and regressors as algorithm choices, many other suitable options exist, and these may also be included in accordance with the judgement of one skilled in this field.

As noted above, the server computer 102 makes, via the PGM 116 at block 212 a set of pipelines 402 that meet the criteria indicated by the PPM 108. It is preferred that pipeline generation occur iteratively, in conjunction with decision block 214, with the server computer 102 iteratively deciding after generating each pipeline 402, whether more pipelines are needed (e.g., pipeline target quantity has been met or a user has indicated that a current set of pipelines is deemed sufficient). It is noted, however, that the entire set of desired pipelines 402 may also generated as a batch (e.g., with parallel processing).

At block 216, the DPM 118 modifies GTD 106 as necessary by applying the preprocessing routines 406 selected for each algorithm 404 associated with the pipelines 402. In this way, sets of algorithm-suited GTD 106 are available for downstream use in pipeline testing.

The server computer 102, generates, via the HGM 120 at block 218, unique sets of hyperparameters for the algorithm associated with each pipeline 402. The hyperparameter set quantity and values are chosen in accordance with the hyperparameter metadata 110. These hyperparameter sets represent alternate, viable options for algorithm testing as known in this field and are passed on for downstream pipeline optimization. It is noted that the hyperparameter metadata 110 may also include a selection algorithm that indicates which of the available hyperparameter values are most likely to achieve performance matching preselected performance criteria. When present, the HGM 120 may use such a selection algorithm to choose hyperparameter values statistically-likely to generate pipelines 402 that exceed related performance thresholds.

The server computer 102, via the HOM 122 at block 220, iteratively runs a training portion of the preprocessed GTD 106 through each of the pipelines 402 with the hyperparameter sets generated by the PGM 116. The HOM 122 assess performance of each pipeline 402 iteratively, comparing performance for each of the associated hyperparameter sets. The HOM 122 determines favored hyperparameter sets for each pipeline 402.

The server computer 102, via APCM 124 at block 222, executes each assembled pipeline with the top hyperparameter sets identified by the HOM 122 and ranks the pipelines (e.g., according to measured performance). It is noted that performance metrics can vary, and desired metrics and thresholds may be provided in many ways (e.g., as part of PPM 108, provided by a user, or supplied in some other convenient manner selected by one skilled in this field as part of interactive pipeline validation).

The server computer 102, via the DPOM 126 in block 224, determines which features (including sentence length, number of unique words, total number of verbs and, total number of nouns and pronouns, and other attributes identified by one skilled in this field) to track when applying the selected pipelines 402 and generates a provisional list of assessment features. The DPOM 126 iteratively runs the pipelines 402, each with favored hyperparameter values, and progressively removes one assessment feature from the provisional list being tracked until performance regarding a selected performance metric undergoes a meaningful step change. As used herein, the phrase meaningful change means a change in performance that drops more than a selected threshold, such as a decrease of 10% or more (e.g., from 98% accuracy down to 88% accuracy, although other drop values could be selected in accordance with the judgment of one skilled in this field). The DPOM 126 will reintroduce the attribute most recently removed from the provisional feature list for the pipeline being measured and formalize that list as the group of most-telling attributes for the given pipeline 402 as tested. The DPOM progressively identifies a group of most-telling attributes for each pipeline 402. With the DPOM 106, the server computer 102 selects groups of data features to consider which strike a balance between pipeline performance and data processing time, by reducing the number of features considered. It is noted that the attribute selection described above may be augmented with domain-specific knowledge or other information provided by user or other source familiar with important characteristics (e.g., trying to process logarithmic values for some kinds of data is inefficient) of the data type being assessed.

The server computer 102 presents to a user for feedback, via the (PVUI) 128 at block, results of applying the pipelines 402 generated by the PGM 116, having top hyperparameter sets identified by the HOM 122 and considering most-telling attributes groups to a remaining holdout portion of GTD 106 processed according to the routines 406 identified by as ranked by the DPOM 126. The group of pipelines 402 for which results are provided is called a list of candidate pipelines, and the PVUI 128 allows a user to assess and interactively select and modify the pipelines 402 on this list. Pipeline performance details are included to provide a high degree of interpretability (e.g., including showing raw GTD to allow users to identify when such data is possibly mislabeled to forgive apparently-poor pipeline performance; which data attributes were graded; what various pipelines provided as results and times when certain pipelines agree; highlight key terms to reveal potential oversights in a given model; and other pipeline aspects selected by one skilled in this field to establish user trust for the selected pipelines). This degree of interpretability allows a user to selectively remove or choose certain pipelines from the candidate pipeline list. The PVUI 128 may request user input before a target quantity of pipelines 402 is generated, allowing a user to indicate satisfaction with a given list of pipelines, even if additional pipelines could be generated. The server computer 102, via the PVUI 226, selects (possibly with user input) a final group of pipelines 402 from the candidate list (which may remain unchanged) and passes the final group of pipelines on for further processing.

The server computer 102, via Ensemble Assembly Module 130 at block 228 collects the final group of pipelines 402 into a cooperative group that will collectively assess data provided. If the ensemble includes an odd number of pipelines 402 greater than three, then the ensemble may be useful to consistently provide a majority result for all results of data tested. The server computer 102, at block 230, applies the ensemble or group of pipelines 402 to user data and generates results. The server computer 102, at block 232 provides results (e.g., through a display, recording device, or some other arrangement selected by on skilled in this field) for further storage or use.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

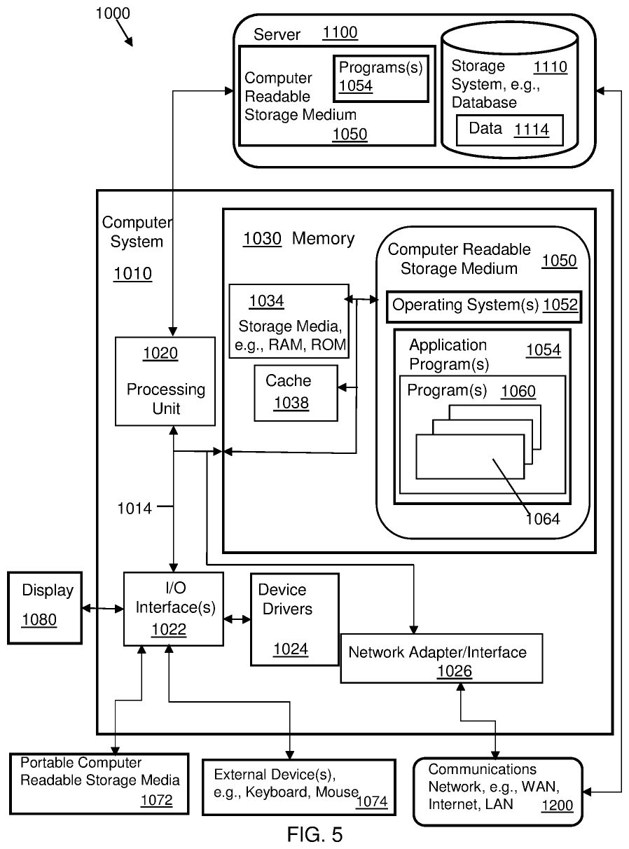

Referring to FIG. 5, a system or computer environment 1000 includes a computer diagram 1010 shown in the form of a generic computing device. The method 100, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 (shown in FIG. 5) can include all or part of the computer system 1010 and its components, and/or the control system can communicate with all or part of the computer system 1010 and its components as a remote computer system, to achieve the control system functions described in the present disclosure. It is also understood that the one or more communication devices 110 shown in FIG. 1 similarly can include all or part of the computer system 1010 and its components, and/or the communication devices can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

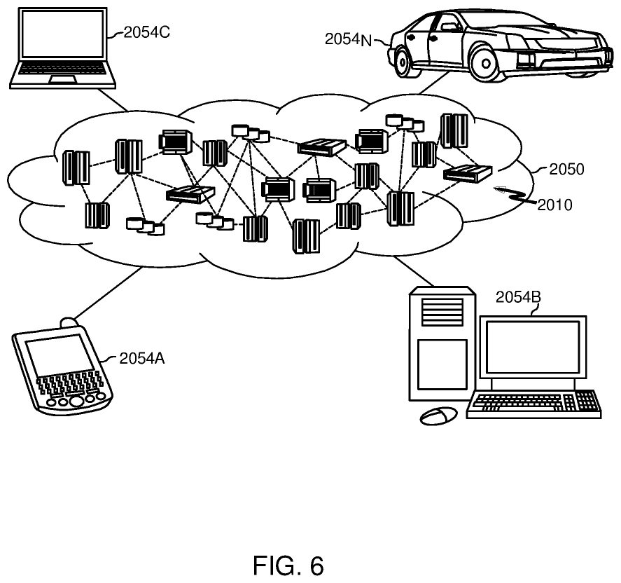

Referring now to FIG. 6, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 6 are intended to be illustrative only and that computing nodes 2010 and cloud computing environment 2050 can communicate with any type of computerized device over any type of network and/or network addressable connection (e.g., using a web browser).

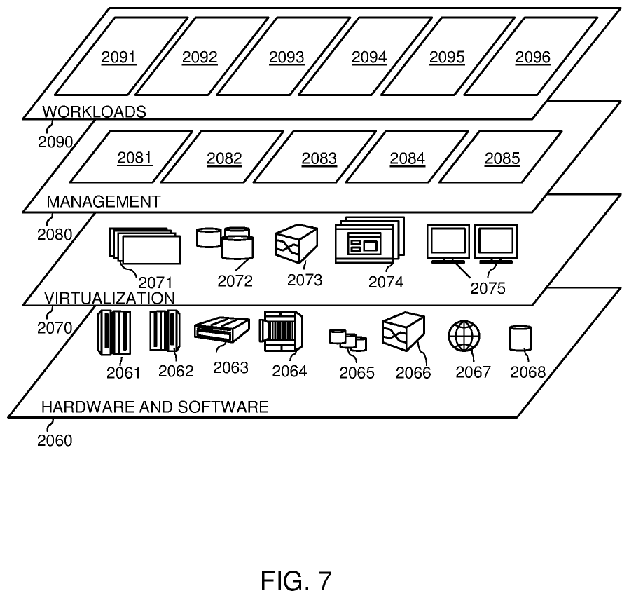

Referring now to FIG. 7, a set of functional abstraction layers provided by cloud computing environment 2050 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and using meta-learning to optimize automatic selection of machine learning pipelines 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method of automatically selecting a machine learning model pipeline using a meta-learning machine learning model, said method comprising:
receiving, by said computer, ground truth data and pipeline preference metadata;
determining, by said computer, a plurality of pipelines appropriate for said ground truth data, wherein each of said plurality of pipelines includes an algorithm and at least one said pipelines includes an associated data preprocessing routine;
generating, by said computer, a target quantity of hyperparameter sets for each of said plurality of pipelines;
applying, by said computer, said preprocessing routines to said ground truth data to generate a plurality of preprocessed sets of said ground truth data;
ranking, by said computer, hyperparameter performance of each of said hyperparameter sets for each of said pipelines to establish a preferred set of hyperparameters for each of said plurality of pipelines;
applying, by said computer, a sentence embedding algorithm to select favored data features;
applying, by said computer, each said pipelines with said preferred set of hyperparameters to score said favored data features of an appropriately preprocessed one of said plurality of preprocessed sets of ground truth data and ranking pipeline performance in accordance therewith; and
selecting, by said computer, a candidate pipeline in accordance, at least in part, with said pipeline performance ranking.

2. The method of claim 1, wherein said ranking of said pipeline performance is based, as least in part, on a pipeline attribute provided by a user.

3. The method of claim 1 further including assembling a plurality of pipelines into a cooperative ensemble.

4. The method of claim 3, wherein occurrences of pipeline scoring agreement are highlighted.

5. The method of claim 3, wherein said ensemble is presented to a user for feedback, and pipelines in the ensemble are selectively removed from said ensemble in accordance with said feedback.

6. The method of claim 1, wherein said favored data features are selected, at least in part, in consideration of data processing time.

7. The method of claim 1 further including receiving, by said computer, domain knowledge regarding said data features from a user and applying said domain knowledge as a form of feature engineering.

8. The method of claim 1, wherein said ranking of said pipeline performance is based, at least in part, in consideration of data scoring accuracy.

9. The method of claim 1, wherein said sets of hyperparameters are selected, at least in part, in accordance with a statistical likelihood of providing best performance for the algorithms associated with said hyperparameters.

10. A system of automatically selecting a machine learning model pipeline using a meta-learning machine learning model, which comprises:
a computer system comprising a computer readable storage medium having program instructions embodied therewith, the program instructions executable by a computer to cause the computer to:
receive ground truth data and pipeline preference metadata;
determine a plurality of pipelines appropriate for said ground truth data, wherein each of said plurality of pipelines includes an algorithm and at least one said pipelines includes an associated data preprocessing routine;
generate a target quantity of hyperparameter sets for each of said plurality of pipelines;
apply said preprocessing routines to said ground truth data to generate a plurality of preprocessed sets of said ground truth data;
rank hyperparameter performance of each of said hyperparameter sets for each of said pipelines to establish a preferred set of hyperparameters for each of said plurality of pipelines;
apply a sentence embedding algorithm to select favored data features;
apply each said pipelines with said preferred set of hyperparameters to score said favored data features of an appropriately preprocessed one of said plurality of preprocessed sets of ground truth data and ranking pipeline performance in accordance therewith; and
select a candidate pipeline in accordance, at least in part, with said pipeline performance ranking.

11. The system of claim 10, wherein said ranking of said pipeline performance is based, as least in part, on a pipeline attribute provided by a user.

12. The system of claim 10 further including assembling a plurality of pipelines into a cooperative ensemble.

13. The system of claim 12, wherein occurrences of pipeline scoring agreement are highlighted.

14. The system of claim 12, wherein said ensemble is presented to a user for feedback, and pipelines in the ensemble are selectively removed from said ensemble in accordance with said feedback.

15. The system of claim 10, wherein said favored data features are selected, at least in part, in consideration of data processing time.

16. The system of claim 10 further including receiving, by said computer, domain knowledge regarding said data features from a user and applying said domain knowledge as a form of feature engineering.

17. The system of claim 10, wherein said ranking of said pipeline performance is based, at least in part, in consideration of data scoring accuracy.

18. The system of claim 10, wherein said sets of hyperparameters are selected, at least in part, in accordance with a statistical likelihood of providing best performance for the algorithms associated with said hyperparameters.

19. A computer program product to automatically select a machine learning model pipeline using a meta-learning machine learning model optimize input component enablement for a plurality of participants in an electronic group meeting, the computer program product comprising a computer readable storage medium having program instructions embodied therewith, the program instructions executable by a computer to cause the computer to:
receive, using said computer, ground truth data and pipeline preference metadata;
determine, using said computer, a plurality of pipelines appropriate for said ground truth data, wherein each of said plurality of pipelines includes an algorithm and at least one said pipelines includes an associated data preprocessing routine;
generate, using said computer, a target quantity of hyperparameter sets for each of said plurality of pipelines;
apply, using said computer, said preprocessing routines to said ground truth data to generate a plurality of preprocessed sets of said ground truth data;
rank, using said computer, hyperparameter performance of each of said hyperparameter sets for each of said pipelines to establish a preferred set of hyperparameters for each of said plurality of pipelines;
apply, using said computer, a sentence embedding algorithm to select favored data features;
apply, using said computer, each said pipelines with said preferred set of hyperparameters to score said favored data features of an appropriately preprocessed one of said plurality of preprocessed sets of ground truth data and ranking pipeline performance in accordance therewith; and
select, using said computer, a candidate pipeline in accordance, at least in part, with said pipeline performance ranking.

20. The computer program product of claim 19, further including:
assembling, using said computer, a plurality of pipelines into a cooperative ensemble;
presenting, using said computer, said cooperative ensemble to a user for feedback; and
selectively removing, using said computer, pipelines from said ensemble in accordance with said feedback.
